(19) United States
(12) Patent Application Publication
(10) Pub. No.: US 2025/0218670 A1
(43) Pub. Date: Jul. 3, 2025

(54) MULTILAYER ELECTRONIC COMPONENT

(71) Applicant: SAMSUNG ELECTRO-MECHANICS CO., LTD., Suwon-si (KR)

(72) Inventors: Won Chul SIM, Suwon-si (KR); Soo Hwan SON, Suwon-si (KR); Young Ghyu AHN, Suwon-si (KR)

(73) Assignee: SAMSUNG ELECTRO-MECHANICS CO., LTD., Suwon-si (KR)

(21) Appl. No.: 18/965,286

(22) Filed: Dec. 2, 2024

(30) Foreign Application Priority Data
Dec. 28, 2023 (KR) 10-2023-0194538

(51) Int. Cl. H01G 4/012; H01G 4/12; H01G 4/30

(52) U.S. Cl. CPC H01G 4/012; H01G 4/30; H01G 4/1227

(57) ABSTRACT

In a multilayer electronic component according to an example embodiment of the present disclosure, a floating electrode layer may include a third electrode pattern including a first main portion overlapping at least a portion of the first electrode pattern in the first direction, a second main portion overlapping at least a portion of the second electrode pattern in the first direction, and a pair of connection portions connecting the first main portion and the second main portion and spaced apart from each other in the third direction with a space portion interposed therebetween, and when a maximum width of the third electrode pattern in the third direction is defined as W1, and a maximum width of the space portion in the third direction is defined as W2, W2/W1 may satisfy 0.08 or more and 0.92 or less.

### CROSS-REFERENCE TO RELATED APPLICATION(S)

The present application claims the benefit of priority to Korean Patent Application No. 10-2023-0194538, filed on Dec. 28, 2023 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic capacitor (MLCC), a multilayer electronic component, is a chip-type condenser, mounted on the printed circuit boards of various types of electronic products, such as image display devices including a liquid crystal display (LCD) and a plasma display panel (PDP), computers, smartphones and mobile phones, an on-board charger (OBC) of an electric vehicle, and circuits such as DC-DC converter, and serves to charge or electricity therein or discharge electricity therefrom.

When voltage is applied to a multilayer ceramic capacitor, stress may occur inside the multilayer ceramic capacitor due to an electrostriction phenomenon of a dielectric layer, which may cause a decrease in the reliability, including BDV characteristics, of the multilayer ceramic capacitor.

Conventionally, attempts have been made to alleviate the electrostriction phenomenon by introducing a floating electrode layer structure.

However, although the internal electrode structure introducing a general floating electrode layer may achieve an effect of entirely distributing a voltage, with an increase in the electrostriction tensile stress in a center region in which upper and lower electrode patterns do not overlap each other, a problem of electrostriction cracks or burnt defects may occur.

Accordingly, structural improvement is needed to suppress a phenomenon of electrostriction tensile stress increasing in the center region in which the upper and lower electrode patterns of the internal electrode structure introducing the floating electrode layer do not overlap each other.

### SUMMARY

An aspect of the present disclosure is to suppress the phenomenon in which electrostriction tensile stress is concentrated in a region in which upper and lower electrode patterns do not overlap each other, in a multilayer electronic component having an internal electrode structure including a floating electrode layer.

However, the aspects of the present disclosure are not limited to the above-described contents, and may be more easily understood in the process of describing specific embodiments of the present disclosure.

A multilayer electronic component according to example embodiment may include: a body including a dielectric layer and an internal electrode layer and a floating electrode layer alternately arranged in a first direction with the dielectric layer interposed therebetween, and including a first surface and a second surface opposing each other in the first direction, a third surface and a fourth surface opposing each other in a second direction, perpendicular to the first direction, and a fifth surface and a sixth surface opposing each other in a third direction, perpendicular to the first direction and the second direction; and external electrodes respectively disposed on the third surface and the fourth surface, and the internal electrode layer may include a first electrode pattern in contact with the third surface, and a second electrode pattern in contact with the fourth surface and spaced apart from the first electrode pattern in the second direction, the floating electrode layer may include a third electrode pattern including a first main portion overlapping at least a portion of the first electrode pattern in the first direction, a second main portion overlapping at least a portion of the second electrode pattern in the first direction, and a pair of connection portions connecting the first main portion and the second main portion and spaced apart from each other in the third direction with a space portion interposed therebetween, and when a maximum width of the third electrode pattern in the third direction is defined as W1, and a maximum width of the space portion in the third direction is defined as W2, W2/W1 may satisfy 0.08 or more and 0.92 or less.

One of the various effects of the present disclosure is to suppress an occurrence of electrostriction cracks in a multilayer electronic component by forming a space portion in a region of a floating electrode layer in which upper and lower electrode patterns do not overlap each other, and adjusting a shape of the floating electrode layer and the space portion to offset the electrostriction tensile stress concentrated in the region of the floating electrode layer in which the upper and lower electrode patterns do not overlap each other, in a multilayer electronic component having an internal electrode structure including the floating electrode layer.

Advantages and effects of the present disclosure are not limited to the foregoing content and may be more easily understood in the process of describing a specific example embodiment of the present disclosure.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an example embodiment of the present disclosure;

FIG. 2 is a cross-sectional view taken along line I-I′ of FIG. 1;

FIG. 3 is a cross-sectional view taken along line II-II′ of FIG. 1;

FIG. 4 is a cross-sectional view taken along line III-III′ of FIG. 1;

FIG. 5 is a cross-sectional view taken along line IV-IV′ of FIG. 1;

FIG. 6 is an exploded perspective view schematically illustrating a shape in which a first electrode pattern, a second electrode pattern, and a third electrode pattern according to an example embodiment are stacked;

FIG. 7A is a plan view schematically illustrating a structure of an internal electrode layer according to an example embodiment, and FIG. 7B is a plan view schematically illustrating a structure of a floating electrode layer according to an example embodiment;

FIG. 8 is a first and second directional cross-sectional view of a multilayer electronic component according to Comparative Example;

FIG. 9 is a graph illustrating distribution of electrostriction stress measured along line A-A′ of FIG. 8;

FIG. 10 schematically illustrates a first and second directional cross-section of a multilayer electronic component according to Comparative Example;

FIG. 11 schematically illustrates a first and second directional cross-section of a multilayer electronic component according to Inventive Example;

FIG. 12 is a graph illustrating a distribution of compression residual stress measured along line B-B′ of FIGS. 10 and 11;

FIG. 13A schematically illustrates a first and third directional cross-section of the multilayer electronic component according to Comparative Example, and FIG. 14B schematically illustrates a first and third directional cross-section of the multilayer electronic component according to Comparative Example;

FIG. 14 is a graph illustrating a distribution of compression residual stress measured along line C-C′ of FIGS. 13A and 13B;

FIG. 15 is a schematic diagram illustrating a cross section in a third direction in a second direction after performing a failure voltage test on a multilayer electronic component according to Comparative Example; and

FIG. 16 is a graph illustrating a distribution of electrostriction stress according to positions in a third direction in a multilayer electronic component according to Comparative Example.

### DETAILED DESCRIPTION

Hereinafter, example embodiments of the present disclosure will be described with reference to specific example embodiments and the attached drawings. The example embodiments of the present disclosure may, however, be exemplified in many different forms and should not be construed as being limited to the specific embodiments set forth herein. The example embodiments disclosed herein are provided for those skilled in the art to better explain the present disclosure. Therefore, in the drawings, the shapes and dimensions of elements may be exaggerated for clarity, and the same reference numerals will be used throughout to designate the same or like elements.

In addition, in order to clearly describe the present disclosure in the drawings, contents unrelated to the description are omitted, and since sizes and thicknesses of each component illustrated in the drawings are arbitrarily illustrated for convenience of description, the present disclosure is not limited thereto. In addition, components with the same function within the same range of ideas are described using the same reference numerals. Throughout the specification, when a certain portion “includes” or “comprises” a certain component, this indicates that other components are not excluded and may be further included unless otherwise noted.

In the drawings, a first direction may be defined as a thickness T direction, a second direction may be defined as a length L direction, and a third direction may be defined as a width W direction.

In one or more aspects, the terms “substantially,” “about,” and “approximately” may provide an industry-accepted tolerance for their corresponding terms and/or relativity between items, such as a tolerance of ±1%, ±5%, or ±10% of the actual value stated, and other suitable tolerances.

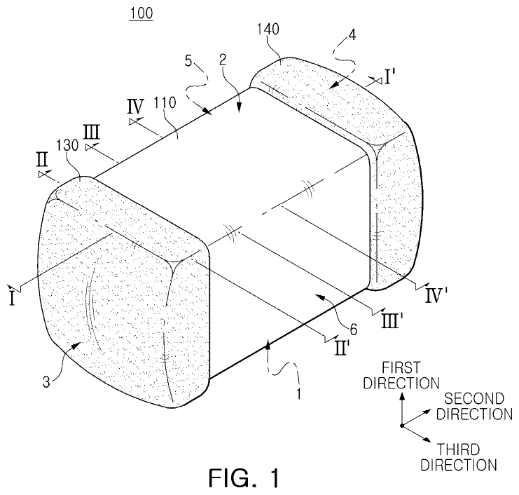

FIG. 1 is a perspective view schematically illustrating a multilayer electronic component according to an example embodiment of the present disclosure.

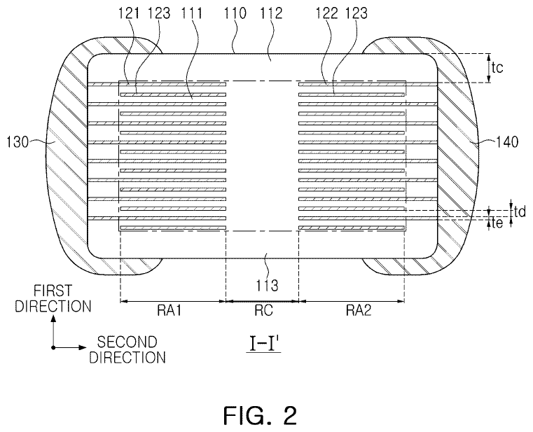

FIG. 2 is a cross-sectional view taken along line I-I′ of FIG. 1.

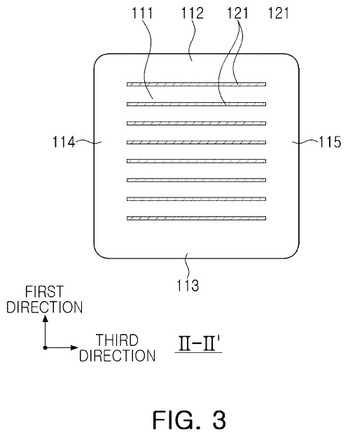

FIG. 3 is a cross-sectional view taken along line II-II′ of FIG. 1.

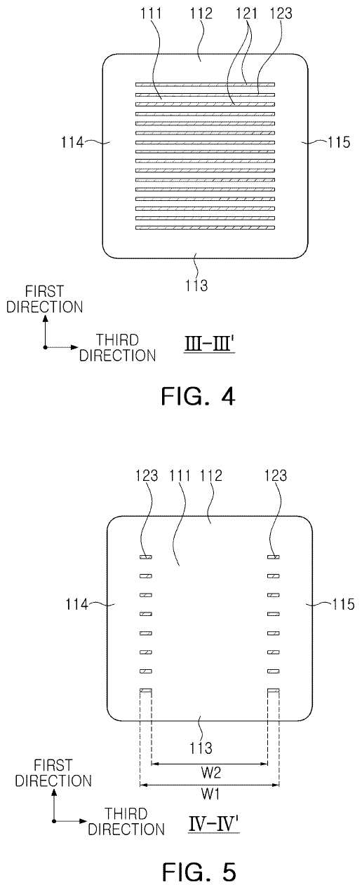

FIG. 4 is a cross-sectional view taken along line III-III′ of FIG. 1.

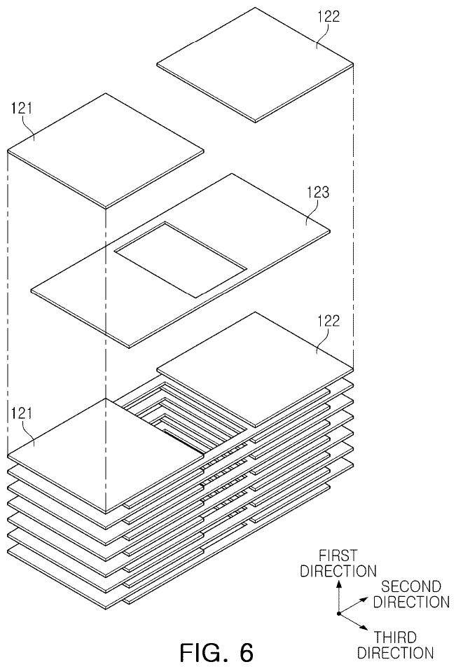

FIG. 5 is a cross-sectional view taken along line IV-IV′ of FIG. 1.

FIG. 6 is an exploded perspective view schematically illustrating a shape in which a first electrode pattern, a second electrode pattern, and a third electrode pattern according to an example embodiment are stacked.

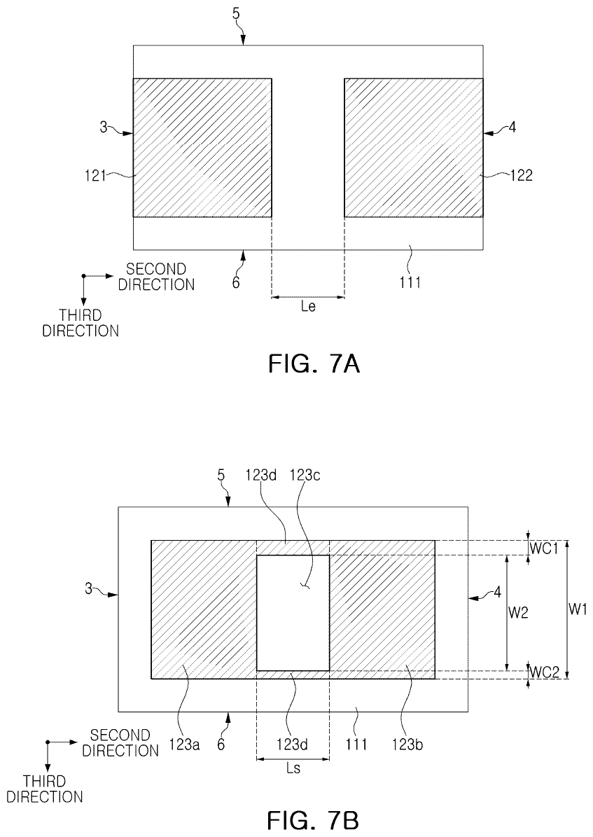

FIG. 7A is a plan view schematically illustrating a structure of an internal electrode layer according to an example embodiment, and FIG. 7B is a plan view schematically illustrating a structure of a floating electrode layer according to an example embodiment.

Hereinafter, a multilayer electronic component 100 according to an example embodiment of the present disclosure and another example embodiment of the present disclosure will be described in detail with reference to FIGS. 1 to 7. Additionally, a multilayer ceramic capacitor (hereinafter defined as ‘MLCC’) is described as an example of a multilayer electronic component, but the present disclosure is not limited thereto, and the multilayer electronic component of the present disclosure may also be applied to various multilayer electronic components using ceramic materials, such as inductors, piezoelectric elements, varistors, or thermistors.

A multilayer electronic component 100 according to an example embodiment of the present disclosure may include: a body 110 including a dielectric layer 111 and an internal electrode layer 121, 122 and a floating electrode layer 123 alternately arranged in a first direction with the dielectric layer 111 interposed therebetween, and including a first surface and a second surface 1 and 2 opposing each other in the first direction, a third surface and a fourth surface 3 and 4 opposing each other in a second direction, perpendicular to the first direction, and a fifth surface and a sixth surface 5 and 6 opposing each other in a third direction, perpendicular to the first direction and the second direction; and external electrodes 130 and 140 respectively disposed on the third surface 3 and the fourth surface 4, and the internal electrode layer may include a first electrode pattern 121 in contact with the third surface 3 and a second electrode pattern 122 in contact with the fourth surface 4 and spaced apart from the first electrode pattern 121 in the second direction, the floating electrode layer may include a third electrode pattern 123 including a first main portion 123a overlapping at least a portion of the first electrode pattern 121 in the first direction, a second main portion 123b overlapping at least a portion of the second electrode pattern 122 in the first direction, and a pair of connection portions 123d connecting the first main portion 123a and the second main portion 123b and spaced apart from each other in the third direction with a space portion 123c interposed therebetween, and when a maximum width of the third electrode pattern 123 in the third direction is defined as W1 and a maximum width of the space portion 123c in the third direction is defined as W2, W2/W1 may satisfy 0.08 or more and 0.92 or less.

The body 110 may include a dielectric layer 111, and an internal electrode layer and a floating electrode layer alternately arranged with the dielectric layer 111 interposed therebetween.

A specific shape of the body 110 is not particularly limited, but as illustrated, the body 110 may have a hexahedral shape or a shape similar thereto. Due to contraction of ceramic powder particles included in the body 110 during a sintering process, the body 110 may not have a hexahedral shape with entirely straight lines but may have a substantially hexahedral shape.

The body 110 may include first and second surfaces 1 and 2 opposing each other in the first direction, third and fourth surfaces 3 and 4 opposing each other in a second direction, perpendicular to the first direction, and fifth and sixth surfaces 5 and 6 opposing each other in a third direction, perpendicular to the first direction and the second direction.

The first to sixth surfaces 1, 2, 3, 4, 5 and 6 of the body 110 may be connected to each other, so that the body 110 may have a substantially hexahedral shape.

On the other hand, as margin regions in which the electrode pattern is not disposed overlap each other on the dielectric layer 111, resulting in an occurrence of a step portion due to a thickness of the internal electrode layer, and thus, a corner connecting the first surface and the third to fifth surfaces and/or a corner connecting the second surface and the third to fifth surfaces may have a shape contracted toward the center of the body 110 in the first direction based on the first surface or the second surface. Alternatively, due to a contraction behavior during the sintering process of the body, a corner connecting the first surface 1 and the third to sixth surfaces 3, 4, 5 and 6 and/or a corner connecting the second surface 2 and the third to sixth surfaces 3, 4, 5 and 6 may have a shape contracted toward the center of the body 110 in the first direction based on the first surface or the second surface. Alternatively, in order to prevent chipping defects, a corner connecting each surface of the body 110 may be rounded by performing a separate process, so that the corner connecting the first surface and the third to sixth surfaces and/or a corner connecting the second surface and the third to sixth surfaces may have a rounded shape.

The dielectric layers 111 forming the body 110 may be formed in plural, and in a state in which a plurality of dielectric layers 111 are sintered, boundaries between adjacent dielectric layers 111 may be integrated to such an extent as to be difficult to identify without using a scanning electron microscope (SEM). The number of stacked dielectric layers 111 is not particularly limited, and may be determined in consideration of the size of the multilayer electronic component. For example, 400 or more dielectric layers may be stacked to form a body.

The dielectric layer 111 may be formed by producing a ceramic slurry containing ceramic powder particles, an organic solvent and a binder, applying and drying the slurry on a carrier film to prepare a ceramic green sheet, and then sintering the ceramic green sheet. The ceramic powder particles are not particularly limited as long as sufficient electrostatic capacitance may be obtained therewith, and for example, barium titanate-based (BaTiO₃) powder particles may be used as the ceramic powder particles. For more specific examples, the ceramic powder particles may be one or more of BaTiO₃, (Ba₁₋ₓCaₓ)TiO₃(0<x<1), Ba(Ti_{1-y}Ca_{y})O₃ (0<y<1), (Ba₁₋ₓCaₓ) (Ti1-yZry)O₃ (0<x<1, 0<y<1), and Ba(Ti_{1-y}Zr_{y})O₃ (0<y<1).

On the other hand, when barium titanate (BaTiO₃)-based powder particles are used as a raw material for forming the dielectric layer 111, the dielectric layer 111 after a sintering process may include Ba and Ti. When the dielectric layer 111 includes Ba and Ti, an electrostriction phenomenon occurring when a high voltage is applied to the multilayer electronic component 100 may be intensified. Specifically, the stress of the multilayer electronic component 100 expanded in the first direction may be generated more strongly, and the possibility of generating cracks in the dielectric layer included in the capacitance non-formation portion may be further increased. However, according to an example embodiment of the present disclosure described below, the third electrode pattern 123 may include a first main portion 123a and a second main portion 123b, and a pair of connection portions 123d spaced apart from each other in the third direction with the space portion 123c interposed therebetween, and when a maximum width of the third electrode pattern in the third direction is defined as W1 and a maximum width of the space portion 123c in the third direction is defined as W2, W2/W1 may be controlled to satisfy 0.08 or more and 0.92 or less to effectively relieve the electrostriction tensile stress concentrated on the capacitance non-formation portion, and even if the dielectric layer includes Ba and Ti, it may be possible to effectively suppress the occurrence of generating electrostriction cracks or generating burnt defects in the multilayer electronic component 100.

An average thickness td of the dielectric layer 111 is not particularly limited. In order to implement miniaturization and high capacitance of the multilayer electronic component 100, the average thickness td of the dielectric layer 111 may be 0.35 μm or less, and in order to improve the reliability of the multilayer electronic component 100 under high temperature and high voltage, the average thickness td of the dielectric layer 111 may be 15 μm or more.

The average thickness td of the dielectric layer 111 may be measured by scanning an image of a third and first directional cross-section (L-T cross-section) of the body 110 with a scanning electron microscope (SEM).

For example, with respect to a total of five dielectric layers, two layers to an upper portion and two layers to a lower portion based on a first layer of the dielectric layer at a point at which a longitudinal center line of the body meets a thickness-direction center line thereof among the dielectric layers extracted from an image of a length and thickness direction (L-T) cross-section obtained by cutting a center of the body 110 in a width direction scanned by the scanning electron microscope (SEM), an average thickness of the dielectric layer 111 may be measured by setting, to equal intervals, five points, that is, two points to the left and two points to the right, centered on the one reference point and then measuring thicknesses of each point, based on the point at which the longitudinal center line of the body meets the thickness-direction center line thereof.

Referring to FIG. 6, the internal electrode layer 121, 122 and the floating electrode layer 123 may be alternately disposed in the first direction. Although omitted in FIG. 6, the dielectric layer 111 may be disposed between the internal electrode layer 121, 122 and the floating electrode layer 123. That is, in an example embodiment of the present disclosure, the internal electrode layer 121, 122 and the floating electrode layer 123 may be alternately disposed in the first direction with the dielectric layer 111 interposed therebetween.

Referring to FIG. 7A, the internal electrode layer may include a first electrode pattern 121 in contact with the third surface 3, and a second electrode pattern 122 in contact with the fourth surface 4 and spaced apart from the first electrode pattern 121 in the second direction.

The first electrode pattern 121 may be connected to a first external electrode 130 described below, and the second electrode pattern 122 may be connected to a second external electrode 140 described below. The first electrode pattern 121 and the second electrode pattern 122 may be spaced apart from each other in the second direction, so that the first electrode pattern 121 and the second electrode pattern 122 may be electrically separated from each other.

Meanwhile, the first electrode pattern 121 and the second electrode pattern 122 may be spaced apart from the fifth surface 5 and the sixth surface 6, thereby improving moisture resistance reliability of the multilayer electronic component 100.

Materials forming the first and second electrode patterns 121 and 122 are not particularly limited, and materials having excellent electrical conductivity may be used. For example, the first and second electrode patterns 121 and 122 may include one or more of nickel (Ni), copper (Cu), palladium (Pd), silver (Ag), gold (Au), platinum (Pt), tin (Sn), tungsten (W), titanium (Ti), and alloys thereof.

The first and second electrode patterns 121 and 122 may be formed by printing a conductive paste on a ceramic green sheet, and a printing method may be a screen-printing method or a gravure printing method, but the present disclosure is not limited thereto.

An average thickness te of the internal electrode layer 121, 122 is not particularly limited.

In order to implement miniaturization and high capacitance of the multilayer electronic component 100, the average thickness te of the internal electrode layer 121, 122 may be 0.35 μm or less, and in order to improve the reliability of the multilayer electronic component 100 under high temperature and high voltage, the average thickness te of the internal electrode layer 121, 122 may be 3 μm or more.

With respect to a total of five internal electrode layers, two layers to an upper portion and two layers to a lower portion based on a first layer of the internal electrode layer 121, 122 at a point at which a center line of each of the capacitance formation portions Ac1 and Ac2 in the longitudinal direction meets a center line thereof in the thickness direction among the internal electrode layers 121, 122 extracted from an image of a length and thickness direction (L-T) cross-section obtained by cutting a center of the body 110 in the width direction scanned by the scanning electron microscope (SEM), an average thickness te of the internal electrode layer 121, 122 may be measured by setting, as equal intervals, five points, that is, two points to the left and two points to the right, centered on the one reference point and then measuring thicknesses of each point, based on the point at which the center line of each of the capacitance formation portions Ac1 and Ac2 in the longitudinal direction meets the center line thereof in the thickness direction.

Referring to FIG. 7B, the floating electrode layer may include a third electrode pattern 123 including a first main portion 123a overlapping at least a portion of the first electrode pattern 121 in the first direction, a second main portion 123b overlapping at least a portion of the second electrode pattern 122 in the first direction, and a pair of connection portions 123d connecting the first main portion 123a and the second main portion 123b and spaced apart from each other in the third direction with the space portion 123c interposed therebetween.

The space portion 123c may increase the compression residual stress applied to the capacitance non-formation portion RC after sintering, thus serving to offset the electrostriction tensile stress applied to the capacitance non-formation portion RC.

At least a portion of the space portion 123c may overlap at least a portion of a region, in the first direction, in which the first electrode pattern 121 and the second electrode pattern 122 are spaced apart from each other in the second direction, thereby effectively offset the electrostriction tensile stress applied to the capacitance non- formation portion RC.

Meanwhile, the space portion 123c may not need to completely overlap at least a portion of the region, in the first direction, in which the first electrode pattern 121 and the second electrode pattern 122 are spaced apart from each other in the second direction. A position of the space portion 123c may be formed to cross the region in which the first electrode pattern 121 and the second electrode pattern 122 are spaced apart from each other in the second direction in consideration of a process error. That is, the space portion 123c may be disposed to be offset in a second direction or a third direction from the region in which the first electrode pattern 121 and the second electrode pattern 122 are spaced apart from each other in the second direction.

However, in the case in which the region in which the first electrode pattern 121 and the second electrode pattern 122 are spaced apart from each other in the second direction is excessively misaligned with the space portion 123c, even when a maximum width of the space portion 123c is adjusted, it may be difficult to effectively offset the electrostriction tensile stress applied to the capacitance non-formation portion RC. Accordingly, when a separation distance in the second direction between the first electrode pattern 121 and the second electrode pattern 122 is defined as Le, and a maximum length of the space portion 123c in the second direction is defined as Ls, Ls/Le may satisfy 0.8 or more and 1.2 or less, thereby effectively offsetting the electrostriction tensile stress applied to the capacitance non-formation portion RC.

Furthermore, referring to FIG. 7B, the pair of connection portions 123d may be divided into a connection portion disposed on one side of the space portion 123c in the third direction and a connection portion disposed on the other side of the space portion 123c in the third direction. In this case, when a third directional maximum width of the connection portion disposed on one side of the space portion 123c in the third direction is defined as WC1 and a third directional maximum width of the connection portion disposed on the other side of the space portion 123c in the third direction is defined as WC2, WC2/WC1 may satisfy 0.8 or more and 1.2 or less, thereby effectively offsetting the electrostriction tensile stress applied to the capacitance formation portion RC.

Meanwhile, the space portion 123c may include the same material as the dielectric layer 111 instead of a conductive material of the third electrode pattern 123. That is, a dielectric material having the same composition as the dielectric material included in the dielectric layer 111 may be disposed in the space portion 123c.

On the other hand, a connection relationship between the space portion 123c is not particularly limited between the first main portion 123a, the second main portion 123b, and the connection portion 123d, but referring to FIG. 7B, the first main portion 123a, the second main portion 123b and the connection portion 123d may be disposed to surround the space portion 123c.

The third electrode pattern 123 may include a conductive metal, and may include the same conductive metal as the conductive metal included in the first and second electrode patterns 121 and 122.

In an example embodiment, the third electrode pattern 123 may be spaced apart from the third surface 3, the fourth surface 4, the fifth surface 5, and the sixth surface 6. Accordingly, the third electrode pattern 123 may not be connected to the external electrodes 130 and 140 described below.

A partial region of the third electrode pattern 123 may overlap a partial region of the first electrode pattern 121 in the first direction, and another partial region of the third electrode pattern 123 may overlap a partial region of the second electrode pattern 122 in the first direction. Specifically, among regions of the third electrode pattern 123 excluding the space portion 123c, electrostatic capacitance may be formed in a region in which the first electrode patterns 121 or the second electrode patterns 122 overlap each other in the first direction, and electrostatic capacitance may not be formed in a region in which the first electrode pattern 121 and the second electrode pattern 122 do not overlap the third electrode pattern 123 in the first direction.

Specifically, referring to FIG. 2, the body 110 according to an example embodiment may include a first capacitance formation portion RA1, a region which the first electrode pattern 121 and the first main portion 123a overlap each other in the first direction, a second capacitance formation portion RA2, a region in which the second electrode pattern 122 and the second main portion 123b overlap each other in the first direction, and a capacitance non-formation portion RC, a region in which the region in which the first electrode pattern 121 and the second electrode pattern 122 are spaced apart from each other in the second direction overlaps the third electrode pattern 123 in the first direction.

Meanwhile, in an example embodiment, the first capacitance formation portion RA1 and the second capacitance formation portion RA2 may be disposed on one surface and the other surface of the non-capacitance formation portion RC in the second direction.

In the case of multilayer electronic components including a floating electrode layer having a conventional general structure, electrostriction tensile stress may be concentrated in a region in which an internal electrode layer and the floating electrode layer do not overlap each other in the first direction, which may result in an occurrence of electrostriction cracks or burnt defects in the multilayer electronic component.

On the other hand, in the case of sintering multilayer electronic components, the capacitance formation portions RA1 and RA2 having a high ratio of electrode patterns have a high metal ratio to have a high contraction rate due to cooling. On the other hand, the capacitance non-formation portion RC has a relatively low ratio of electrode patterns to have a lower contraction rate than the capacitance formation portions RA1 and RA2. Accordingly, residual tensile stress may be generated in the capacitance formation portions RA1 and RA2, and compression residual stress is generated in the capacitance non-formation portion RC.

In an example embodiment of the present disclosure, the third electrode pattern 123 may include the first main portion 123a, the second main portion 123b, and a pair of connection portions 123d spaced apart from each other in the third direction with the space portion 123c interposed therebetween, thereby improving the compressive residual stress of the capacitance non-formation portion RC.

The compressive residual stress of the capacitance non-formation portion RC may offset the above-described electrostriction tensile stress, and may thus serve to alleviate the occurrence of electrostriction cracks and burnt defects of the multilayer electronic component.

Accordingly, in a structure in which the internal electrode layer 121, 122 and the floating electrode layer 123 are alternately disposed in the first direction with the dielectric layer 111 interposed therebetween according to an example embodiment of the present disclosure, the internal electrode layer may include the first electrode pattern 121 in contact with the third surface 3 and the second electrode pattern 122 in contact with the fourth surface 4 and spaced apart from the first electrode pattern 121 in the second direction, and the floating electrode layer may include the third electrode pattern 123 including the first main portion 123a overlapping at least a portion of the first electrode pattern 121 in the first direction, the second main portion 123b overlapping at least a portion of the second electrode pattern 122 in the first direction, and a pair of connection portions 123d connecting the first main portion 123a and the second main portion 123b and spaced apart from each other in the third direction with the space portion 123c interposed therebetween, thereby offsetting the electrostriction tensile stress of the capacitance non-formation portion RC by the compressive residual stress. Accordingly, the occurrence of the electrostriction cracks and the burnt defects in the multilayer electronic component 100 may be alleviated.

On the other hand, in order to more effectively alleviate the occurrence of the electrostriction cracks and the burnt defects in the multilayer electronic component 100, it may be necessary to appropriately adjust a region forming the space portion 123c.

In the case of the multilayer electronic component including the floating electrode layer having the conventional general structure, when a breakdown voltage (BDV) measurement test is conducted to confirm a position of defects in a second and third directional cross-section, cracks may be concentrated in the dielectric layer on the floating electrode layer included in the capacitance non-formation portion.

Specifically, based on the maximum width of the floating electrode layer in the second and third directional cross-section, crack occurrence may be concentrated in the dielectric layer corresponding to a position of 0.08 to 0.92 in the width direction.

Therefore, in an example embodiment of the present disclosure, when a maximum width of the third electrode pattern 123 in the third direction is defined as W1 and a maximum width of the space portion 123c in the third direction is defined as W2,

W2/W1 may satisfy 0.08 or more and 0.92 or less, so that the space portion 123c in which W2/W1 satisfies 0.08 or more and 0.92 or less may be formed in a region of the floating electrode layer in which stress is concentrated, thereby effectively alleviating a problem in which electrostriction cracks occur in the multilayer electronic component 100 or a problem in which a burnt defects occur.

Meanwhile, a method of measuring the maximum width W1 of the third electrode pattern 123 in the third direction and the maximum width W2 of the space portion 123c in the third direction is not particularly limited. For example, in a first and third directional cross-section polished to a second directional center of the multilayer electronic component 100 as illustrated in FIG. 5, based on the third electrode pattern 123 closest to a first directional center, a maximum width of the third electrode pattern 123 in the third direction and a maximum width of the space portion 123c in the third direction may be measured in two or more of the third electrode patterns 123 disposed in an upper portion in the first direction and two or more of the third electrode patterns 123 disposed in a lower portion in the first direction, and then respective average values thereof may be obtained to perform generalization.

As another example of measuring the maximum width W1 of the third electrode pattern 123 in the third direction and the maximum width W2 of the space portion 123c in the third direction, a method of measuring the maximum width W1 of the third electrode pattern 123 in the third direction and the maximum width W2 of the space portion 123c in the third direction may be used in the second and third directional cross-section in which the multilayer electronic component 100 is polished in the first direction to expose the third electrode pattern 123, and such a measurement may be repeated in five or more third electrode patterns 123 disposed on different layers and respective average values thereof may be obtained to perform generalization.

As an example of a method of measuring the maximum width WC1 and WC2 of the connection portion 123d in the third direction, a method of measuring the maximum width WC1 of the connection portion in the third direction disposed on one side of the space portion 123c in the third direction and the maximum width WC2 of the connection portion in the third direction disposed on the other side of the space portion 123c in the third direction may be used in the second and third directional cross-section in which the multilayer electronic component 100 is polished in the first direction to expose the third electrode pattern 123, and such a measurement may be repeated in five or more third electrode patterns 123 disposed on different layers and respective average values thereof may be obtained to perform generalization.

Referring to FIGS. 2 to 5, the body 110 may include cover portions 112 and 113 disposed an upper portion and a lower portion of the first capacitance formation portion RA1, the second capacitance formation portion RA2 and the capacitance non-formation portion RC in the first direction.

The cover portions 112 and 113 may be formed by stacking a single dielectric layer or two or more dielectric layers in the thickness direction on upper and lower surfaces of the first capacitance formation portion RA1, the second capacitance formation portion RA2, and the capacitance non-formation portion RC, respectively, and may basically serve to prevent damage to the internal electrode due to physical or chemical stress.

The cover portions 112 and 113 do not include the internal electrode, and may include a dielectric layer 111 and a dielectric material. That is, the cover portions 112 and 113 may include a ceramic material, and may include, for example, a barium titanate (BaTiO₃) ceramic material.

Meanwhile, a thickness of the cover portions 112 and 113 does not need to be particularly limited. For example, an average thickness tc of the cover portions 112 and 113 may be 10 to 300 μm. The average thickness tc of the cover portions 112 and 113 may refer to a first directional size, and may be a value obtained by averaging first directional sizes of the cover portions 112 and 113 measured at five points spaced apart from each other by equal intervals in the upper portion or the lower portion of the first capacitance formation portion RA1, the second capacitance formation portion RA2 and the capacitance non-formation portion RC.

Margin portions 114 and 115 may be disposed on sides of the first capacitance formation portion RA1, the second capacitance formation portion RA2, and the capacitance non-formation portion RC.

Referring to FIGS. 3 to 5, the margin portions 114 and 115 may be disposed on both end surfaces of the ceramic body 110 in the width direction.

As illustrated in FIGS. 3 to 5, the margin portions 114 and 115 may be a region between both ends of the first electrode pattern 121, the second electrode pattern 122 and the third electrode pattern 123 and a boundary surface of the body 110 in a width-thickness (W-T) direction cross-section of the body 110.

The margin portions 114 and 115 may basically serve to prevent damage to the internal electrode due to physical or chemical stress.

The margin portions 114 and 115 may be formed by applying a conductive paste to the ceramic green sheet except for a region in which the margin portion is to be formed, and forming the first to third electrode patterns.

Additionally, in order to suppress the step portion, the dielectric layer 111, the internal electrode layer and the floating electrode layer may be stacked, and then, the first to third electrode patterns 121, 122 and 123 may be cut to be exposed to the fifth and sixth surfaces 5 and 6 of the body, and a single dielectric layer or two or more dielectric layers may be stacked in the third direction (width direction), thus forming the margin portions 114 and 115.

Meanwhile, a width of the margin portions 114 and 115 does not need to be particularly limited. For example, the width of the margin portions 114 and 115 may be 5 to 300 μm.

An average width of the portions 114 and 115 may refer to an average size of a region, in the third direction, in which the internal electrode is spaced apart from the fifth surface 5, and may refer to an average size of a region, in the third direction, in which the internal electrode is spaced apart from the sixth surface 6, and may be an average value of third directional sizes of the margin portions 114 and 115 measured at five points spaced apart from each other by equal intervals on side surfaces of the first capacitance formation portion RA1, the second capacitance formation portion RA2, and the capacitance non-formation portion RC.

The external electrodes 130 and 140 may be disposed on the third surface 3 and the fourth surface 4 of the body 110.

The external electrodes 130 and 140 may include first and second external electrodes 130 and 140 respectively disposed on the third and fourth surfaces 3 and 4 of the body 110 and connected to the first and second electrode patterns 121 and 122. Specifically, the first external electrode 130 may be disposed on the third surface 3 and connected to the first electrode pattern 121, and the second external electrode 140 may be disposed on the fourth surface 4 and connected to the second electrode pattern 122.

In this example embodiment, a structure in which the multilayer electronic component 100 has two external electrodes 130 and 140 is described, but the number or shape of the external electrodes 130 and 140 may be changed depending on the shape of the internal electrode layer or other purposes.

Meanwhile, the external electrodes 130 and 140 may be formed using any material having electrical conductivity, such as a metal, and a specific material may be determined in consideration of electrical characteristics, structural stability, and the like, and further, the external electrodes 130 and 140 may have a multilayer structure.

For example, the external electrodes 130 and 140 may include an electrode layer disposed on the body 110 and a plating layer formed on the electrode layer.

For a more specific example of the electrode layer, the electrode layer may be a sintered electrode including a conductive metal and glass, or a resin-based electrode including a conductive metal and a resin.

Additionally, the electrode layer may be in the form in which the sintered electrode and the resin-based electrode are sequentially formed on the body. Additionally, the electrode layer may be formed by transferring a sheet including the conductive metal onto the body, or may be formed by transferring a sheet including the conductive metal onto the sintered electrode. Additionally, the electrode layer may be formed as the plating layer, or a layer formed using a deposition method such as a sputtering method or an Atomic layer deposition (ALD).

The conductive metal included in the electrode layer may be a material having excellent electrical conductivity, and is not particularly limited. For example, the conductive metal may be one or more of nickel (Ni), copper (Cu), and alloys thereof.

The plating layer serves to improve mounting characteristics. The type of plating layers is not particularly limited, and may be a plating layer including one or more of Ni, Sn, Pd, and alloys thereof, and may be formed of a plurality of layers.

For a more specific example of the plating layer, the plating layer may be a Ni plating layer or a Sn plating layer, and may be in a form in which the Ni plating layer and the Sn plating layer are sequentially formed on the electrode layer, and may be in a form in which the Sn plating layer, the Ni plating layer, and the Sn plating layer are sequentially formed. Additionally, the plating layer may include a plurality of Ni plating layers and/or a plurality of Sn plating layers. Additionally, the plating layer may be in a form in which the Ni plating layer and the Pd plating layer are sequentially formed on the electrode layer.

A size of the multilayer electronic component 100 does not need to be particularly limited. According to an example embodiment of the present disclosure, since the multilayer electronic component 100 is advantageous for miniaturization and high capacitance, the multilayer electronic component 100 may be applied to the size of small IT products, and since the multilayer electronic component 100 may secure high reliability in various environments, the multilayer electronic component 100 may be applied to the size of automotive electrical products requiring high reliability.

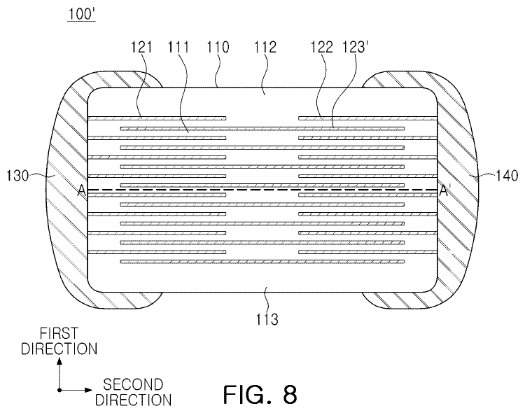

FIG. 8 is a first and second directional cross-sectional view of a multilayer electronic component according to Comparative Example.

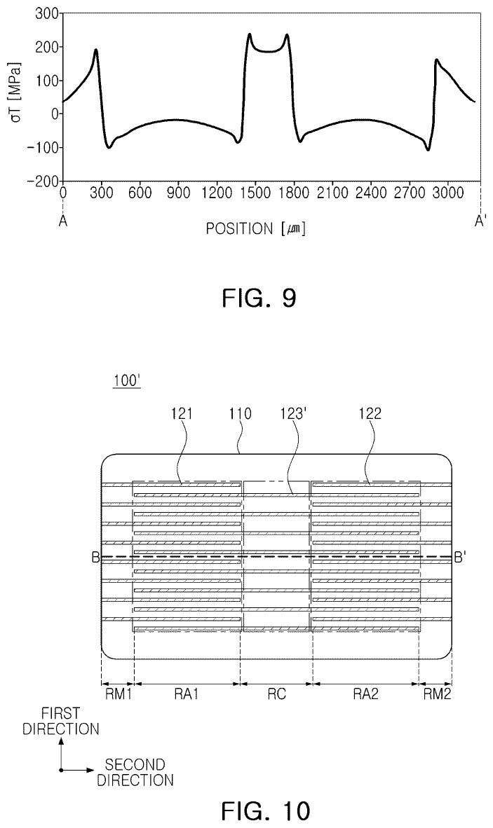

FIG. 9 is a graph illustrating distribution of electrostriction stress measured along line A-A′ of FIG. 8.

FIG. 10 schematically illustrates a first and second directional cross-section of a multilayer electronic component according to Comparative Example.

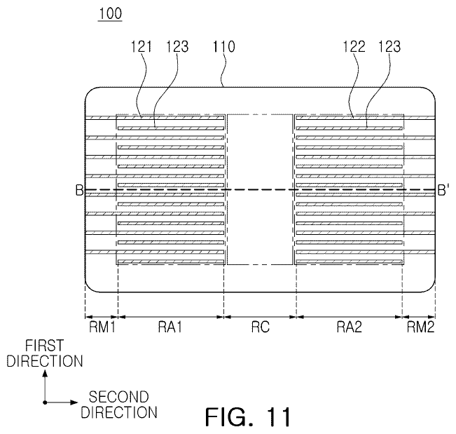

FIG. 11 schematically illustrates a first and second directional cross-section of a multilayer electronic component according to Inventive Example.

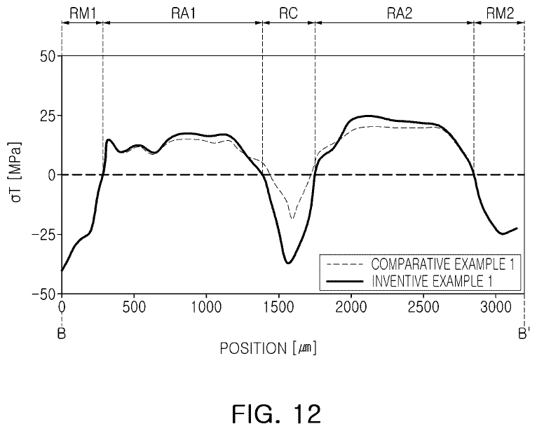

FIG. 12 is a graph illustrating a distribution of compression residual stress measured along line B-B′ of FIGS. 10 and 11.

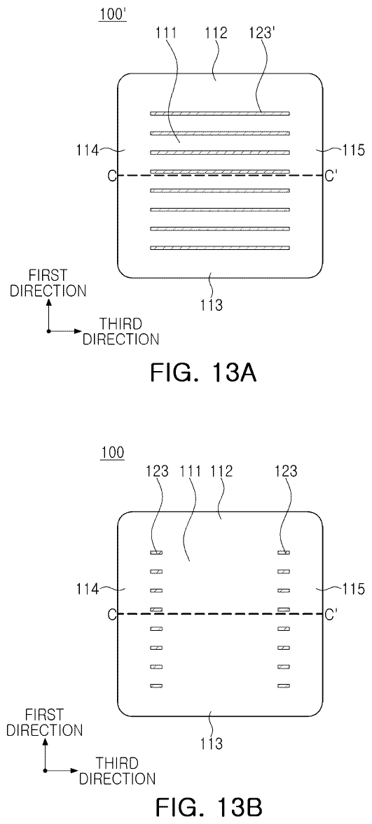

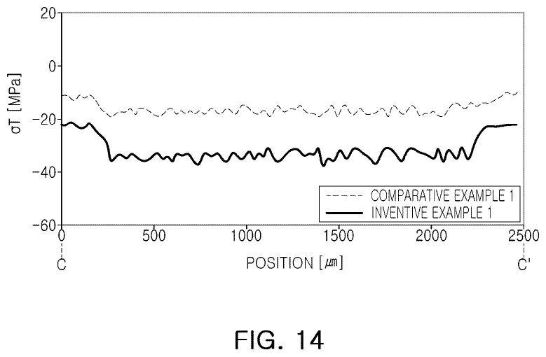

FIG. 13A schematically illustrates a first and third directional cross-section of the multilayer electronic component according to Comparative Example, and FIG. 14B schematically illustrates a first and third directional cross-section of the multilayer electronic component according to Comparative Example.

FIG. 14 is a graph illustrating a distribution of compression residual stress measured along line C-C′ of FIGS. 13A and 13B.

FIG. 15 is a schematic diagram illustrating a cross section in a third direction in a second direction after performing a failure voltage test on a multilayer electronic component according to Comparative Example.

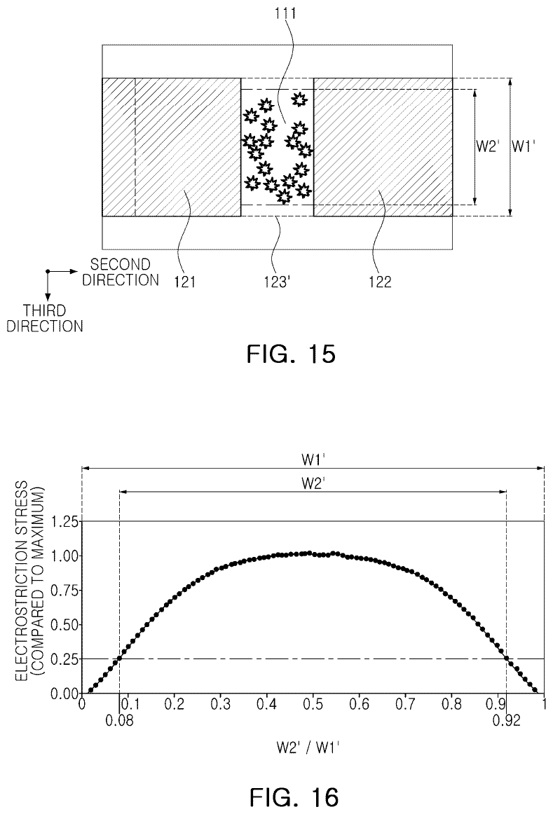

FIG. 16 is a graph illustrating a distribution of electrostriction stress according to positions in a third direction in a multilayer electronic component according to Comparative Example.

Hereinafter, referring to FIGS. 8 to 16, a reason why an effect of alleviating the electrostriction tensile stress concentrated on the capacitance non-formation portion RC in the multilayer electronic component 100′ according to Inventive Example is superior to the multilayer electronic component 100′ according to Comparative Example will be described in detail.

The multilayer electronic component 100′ according to Comparative Example includes a floating electrode layer 123′ that does not include a space portion 123c, unlike the example embodiment of the present disclosure, but the multilayer electronic component 100 according to Inventive Example includes the floating electrode layer 123 in which the space portion 123c is formed, like the example embodiment of the present disclosure.

The remaining components, except for the shape of the floating electrode layers 123 and 123′, are the same in both the multilayer electronic component 100′ according to Comparative Example and the multilayer electronic component 100 according to Inventive Example.

Meanwhile, stress values measured in FIGS. 8 to 16 are values measured in multilayer electronic components 100 and 100′ having size 3225 (length×width×thickness=3.2 mm×2.5 mm×2.5 mm), but it should be noted that the present disclosure does not intend to limit the size of the multilayer electronic component 100 to size 3225.

FIG. 8 is a cross-sectional view of the multilayer electronic component in the first and second directions according to Comparative Example.

FIG. 9 is a graph illustrating a distribution of the electrostriction stress measured along line A-A′ of FIG. 8.

The line A-A′ of FIG. 8 may be a straight line connecting one end and the other end of the dielectric layer 111, in the second direction, disposed in a first directional center of the body 110, in the first and second directional cross-section polished to a third directional center of the multilayer electronic component 100′ according to Comparative Example.

FIG. 9 corresponds to the results of measuring electrostriction stress along line A-A′ in the multilayer electronic component 100′ according to Comparative Example. Referring to FIG. 9, it may be confirmed that the electrostriction tensile stress is concentrated in the region of about 1300 μm to 1900 μm, a region in which a region in which the first electrode pattern 121 and the second electrode pattern 122 are spaced apart from each other overlaps the third electrode pattern 123 in the first direction. That is, in the case of the comparative example having a general floating electrode structure, it may be seen that the electrostriction tensile stress is concentrated in the capacitance non-formation region, a region in which the first and second electrode patterns 121 and 122 and the third electrode pattern 123′ do not overlap each other in the first direction.

FIG. 10 schematically illustrates the first and second directional cross-section of the multilayer electronic component according to Comparative Example.

FIG. 11 schematically illustrates the first and second direction cross-section of the multilayer electronic component according to Inventive Example.

FIG. 12 is a graph illustrating a distribution of compressive residual stress measured along line B-B′ of FIGS. 10 and 11.

The line B-B′ of FIGS. 10 and 11 may correspond to a straight line connecting one end and the other end of the dielectric layer 111, in the second direction, disposed in the first directional center of the body 110, in the first and second directional cross-section polished to the third directional center of the multilayer electronic component 100′.

Referring to FIG. 12, the distribution of the compressive residual stress according to the position of the line B-B′ may be confirmed. Specifically, it may be confirmed that the size of the compressive residual stress of Inventive Example indicated by a solid line has a relatively larger value than that of Comparative Example indicated by a dotted line.

That is, in the case in which the floating electrode layer, as in an example embodiment of the present disclosure, includes the third electrode pattern 123 including the first main portion 123a overlapping at least a portion of the first electrode pattern 121 in the first direction, the second main portion 123b overlapping at least a portion of the second electrode pattern 122 in the first direction, and a pair of connecting portions 123d connecting the first main portion 123a and the second main portion 123b and spaced apart from each other in the third direction with the space portion 123c interposed therebetween, the size of the compressive residual stress in the capacitance non-formation portion RC may be improved as compared to the conventional case.

FIG. 13A schematically illustrates a first and third directional cross-section of a multilayer electronic component according to Comparative Example, and FIG. 13B schematically illustrates the first and third directional cross-section of the multilayer electronic component according to Comparative Example.

FIG. 14 is a graph illustrating a distribution of compressive residual stress measured along line C-C′ of FIG. 13A and FIG. 13B.

The line C-C′ of FIG. 13A and FIG. 13B may correspond to a straight line connecting one end and the other end of the dielectric layer 111, in the third direction, disposed in the first directional center of the body 110, in a first and third directional cross-section polished to a second directional center of the multilayer electronic component 100′.

Referring to FIG. 14, the distribution of compressive residual stress according to the position of the line C-C′ may be confirmed. Specifically, it may be confirmed that the size of the compressive residual stress of Inventive Example indicated by the solid line has a relatively larger value than that of Comparative Example indicated by the dotted line.

That is, in the case in which the floating electrode layer, as in an example embodiment of the present disclosure, includes the third electrode pattern 123 including the first main portion 123a overlapping at least a portion of the first electrode pattern 121 in the first direction, the second main portion 123b overlapping at least a portion of the second electrode pattern 122 in the first direction, and a pair of connecting portions 123d connecting the first main portion 123a and the second main portion 123b and spaced apart from each other in the third direction with the space portion 123c interposed therebetween, the size of the compressive residual stress in the capacitance non-formation portion RC may be improved as compared to the conventional case.

FIG. 15 is a schematic diagram illustrating a second and third directional cross-section observed after a breakdown voltage test was performed on a multilayer electronic component according to Comparative Example.

FIG. 16 is a graph illustrating a distribution of the electrostriction stress for each position in the third direction in the multilayer electronic component according to Comparative Example.

FIG. 15 is a schematic diagram of a result obtained after a breakdown voltage (BDV) measurement test was performed on the multilayer electronic component 100′ according to Comparative Example and a second and third directional cross-section was polished to expose the first electrode pattern 121 and the second electrode pattern 122. Referring to FIG. 15, a floating electrode layer 123′ according to Comparative Example is indicated by a dotted line, and a region in which cracks are concentrated is indicated by a dashed line.

The breakdown voltage (BDV) measurement test was performed on a sample of the multilayer electronic component 100′ according to the comparative example by an applied voltage of 1.5 to 2.5 kV, using a withstanding voltage insulation tester (19052 AC/DC HIPOT Tester made by Chroma), and when the insulation resistance decreased by 100 times or more as compared to an initial value, it was determined that the breakdown phenomenon occurred.

As a result of the breakdown voltage (BDV) measurement test, among the dielectric layers 111 disposed in a region in which the first electrode pattern 121 and the second electrode pattern 122 are spaced apart from each other in the second direction, when a maximum size of a third directional width of the floating electrode layer 123′ is defined as W1′, and a maximum size of a width of a region in which the crack occurred is defined as W2′, it was confirmed that the cracks occurred in a region in which W2′/W1′ satisfied 0.08 or more and 0.92 or less.

Specifically, FIG. 16 illustrates the electrostriction stress from one end to the other end of a region, in the third direction, disposed on the floating electrode layer 123′ among the dielectric layers 111 disposed in a first directional center, in the first and third directional cross-section polished to the second directional center of the multilayer electronic component 100′ according to Comparative Example.

A horizontal axis is expressed as a ratio (W2′/W1′) of a maximum size (W2′) of a width of the region in which cracks occurred, to a maximum size (W1′) of a third directional width of the floating electrode layer 123′ by utilizing one third directional end of a region disposed on the floating electrode layer 123′ as an origin point, among the dielectric layers 111 disposed in the first directional center, in the first and third directional cross-section polished to the second direction center of the multilayer electronic component 100′ according to Comparative Example.

In summary of FIGS. 15 and 16, it may be confirmed that large amounts of defects occur in the region in which stress of 25% or more as compared to a maximum stress value occurs, and a frequency of defect occurrence decreases when this region is deviated.

Accordingly, in an example embodiment of the present disclosure, in a structure in which the floating electrode layer includes the third electrode pattern 123 including the first main portion 123a and the second main portion 123b, and a pair of connecting portions 123d spaced apart from each other in the third direction with the space portion 123c interposed therebetween, when the maximum width of the third electrode pattern 123 in the third direction is defined as W1 and the maximum width of the space portion 123c in the third direction is defined as W2, W2/W1 may be adjusted to satisfy 0.08 or more and 0.92 or less, so that the problem of electrostriction cracks occurring in the multilayer electronic component 100 or the problem of burnt defects occurring may be effectively alleviated.

Although the example embodiment of the present disclosure has been described in detail above, the present disclosure is not limited to the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ used in the present disclosure does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the terms are merely used to describe a specific embodiment, and are not intended to limit the present disclosure. Singular forms may include plural forms as well unless the context clearly indicates otherwise.

What is claimed is:

1. A multilayer electronic component, comprising:
a body including a dielectric layer and an internal electrode layer and a floating electrode layer alternately arranged in a first direction with the dielectric layer interposed therebetween, and including a first surface and a second surface opposing each other in the first direction, a third surface and a fourth surface opposing each other in a second direction, perpendicular to the first direction, and a fifth surface and a sixth surface opposing each other in a third direction, perpendicular to the first direction and the second direction; and
external electrodes respectively disposed on the third surface and the fourth surface,
wherein the internal electrode layer includes a first electrode pattern in contact with the third surface, and a second electrode pattern in contact with the fourth surface and spaced apart from the first electrode pattern in the second direction,
the floating electrode layer includes a third electrode pattern including a first main portion overlapping at least a portion of the first electrode pattern in the first direction, a second main portion overlapping at least a portion of the second electrode pattern in the first direction, and a pair of connection portions connecting the first main portion and the second main portion and spaced apart from each other in the third direction with a space portion interposed therebetween, and
when a maximum width of the third electrode pattern in the third direction is defined as W1, and a maximum width of the space portion in the third direction is defined as W2, W2/W1 satisfies 0.08 or more and 0.92 or less.

2. The multilayer electronic component according to claim 1, wherein the third electrode pattern is spaced apart from the third surface, the fourth surface, the fifth surface and the sixth surface.

3. The multilayer electronic component according to claim 1, wherein at least a portion of the space portion overlaps at least a portion of a region, in the first direction, in which the first electrode pattern and the second electrode pattern are spaced apart from each other in the second direction.

4. The multilayer electronic component according to claim 1, wherein the space portion is disposed to offset in the second direction or the third direction from a region in which the first electrode pattern and the second electrode pattern are spaced apart from each other.

5. The multilayer electronic component according to claim 1, wherein the space portion includes a dielectric material having a same composition as a dielectric material included in the dielectric layer.

6. The multilayer electronic component according to claim 1, wherein when a separation distance in the second direction between the first electrode pattern and the second electrode pattern is defined as Le, and a maximum length of the space portion in the second direction is defined as Ls, Ls/Le may satisfy 0.8 or more and 1.2 or less.

7. The multilayer electronic component according to claim 1, wherein the first electrode pattern and the second electrode pattern are spaced apart from the fifth surface and the sixth surface.

8. The multilayer electronic component according to claim 1, wherein the body includes a first capacitance formation portion, in which the first electrode pattern and the first main portion overlap each other in the first direction, a second capacitance formation portion, in which the second electrode pattern and the second main portion overlap each other in the first direction, and a capacitance non-formation portion, in which a region in which the first electrode pattern and the second electrode pattern are spaced apart from each other in the second direction overlaps the third electrode pattern in the first direction.

9. The multilayer electronic component according to claim 8, wherein the first capacitance formation portion and the second capacitance formation portion are disposed on one surface and the other surface of the capacitance non-formation portion in the second direction.

10. The multilayer electronic component according to claim 1, wherein when a third directional maximum width of the connection portion disposed on one side of the space portion in the third direction is defined as WC1, and a third directional maximum width of the connection portion disposed on the other side of the space portion in the third direction is defined as WC2,
WC2/WC1 satisfies 0.8 or more and 1.2 or less.

11. The multilayer electronic component according to claim 1, wherein an average thickness of the dielectric layer is 15 μm or more.

12. The multilayer electronic component according to claim 1, wherein the dielectric layer includes Ba and Ti.

13. The multilayer electronic component according to claim 1, wherein the space portion is surrounded by the pair of connection portions, the first main portion, and the second main portion and has a rectangular shape.

14. The multilayer electronic component according to claim 1, wherein the third electrode pattern includes a conductive metal that is same as a conductive metal included in the first and second electrode patterns.
